(19) United States
(12) Patent Application Publication
(10) Pub. No.: US 2005/0209124 A1
(43) Pub. Date: Sep. 22, 2005

(54) Solid polyethylene glycol in powder form with bimodal particle size distribution, its production and its use

(75) Inventors: Torsten Henning, Bad Soden (DE); Georg Borchers, Bad Nauheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/057,020

(22) Filed: Feb. 11, 2005

(30) Foreign Application Priority Data
Feb. 11, 2004 (DE) 102004006670.1

(51) Int. Cl. C11D 17/00

(52) U.S. Cl. 510/446

(57) ABSTRACT

A solid polyethylene glycol with an average molecular mass of from 1500 to 40 000 in the form of a powder with a bimodal particle size distribution, with from 0 to 15% by weight of particles smaller than 100 micrometers, 10 to 90% by weight of particles between 100 and 200 micrometers, 0 to 25% by weight of particles between 200 and 300 micrometers, 10 to 90% by weight of particles between 300 and 1000 micrometers and 0 to 10% by weight of particles larger than 1000 micrometers is claimed.

The invention relates to a polyethylene glycol which is solid at room temperature and is in powder form with a bimodal particle size distribution, its preparation and its use as aid in tablet production and/or melt granulation.

Polyethylene glycol (abbreviation PEG) with the general formula H(OCH₂CH₂)ₙOH is, when n is above about 32, corresponding to an average molecular mass of about 1500, solid enough to be converted into powder form. Owing to the interesting properties, it is employed in a large number of application areas. One important application area of PEGs which are solid at room temperature and are in powder form with an average molecular mass above about 1500, preferably from 3000 to 20 000, particularly preferably from 3350 to 8000, is the use as aid in tablet production. The PEG can in this case undertake very different functions depending on the process. PEG acts, for example, as lubricant and binder. Depending on the chosen molecular mass, the melting point can be so low that the PEG melts under the pressure of compression and makes so-called sinter techniques or compression techniques possible. In these cases, the PEG also acts as shaping agent and helps to maintain the tablet shape. In the specific case of melt granulation with subsequent tablet compression, the PEG can serve additionally as carrier substance, solubilizer or absorption promoter of active ingredients.

Solid PEGs are also frequently employed as release agents in coatings of film-coated tablets, and specifically as mold release agent during the production process.

In all these applications, the particle size distribution of the powder is of crucial importance.

In many cases, PEG with very different particle sizes is required in order to be able to fulfill simultaneously the different functions detailed above. For example, a fines content of PEG powder is important in melt granulation (Pharmazie 55 (12-2000)919-924), whereas coarse PEG particles are more favorable for the subsequent actual tableting.

In these cases it is therefore necessary for a plurality of different PEG powders with quite different particle size distribution to be mixed together before or during the processing. The homogeneous mixing of solids differing in particle size distribution requires great effort or is frequently just not possible with complete homogeneity.

If the fines content with particle sizes below about 100 micrometers in a PEG powder to be mixed in is too high there is a risk of a dust explosion, additionally requiring elaborate measures such as packaging materials and systems able to eliminate electric charge, or limitation of the amounts processed each time.

PEG powders available on the market are produced either by grinding of coarse material or spraying of molten material. Both processes lead only to a monomodal particle size distribution with a relatively narrow distribution, as is evident from the PEG powders available on the market, such as, for example, Carbowax from Dow/UCC, Pluriol E from BASF or Polyglykol from Clariant.

The object therefore was to produce a PEG powder which has a very broad distribution of particle sizes with, at the same time, strictly limited fines and coarse contents or, preferably, a bimodal particle size distribution.

Production is possible from the hot PEG melt by conventional processes for spraying and cooling melts, for example by the process described in EP 0 945 173, or by conventional processes for dropletizing and cooling melts with vibrating nozzle orifice plates, for example in processes available from the companies Brace GmbH, Alzenau, Germany, as microsphere system or Rieter Automatik GmbH, Groβostheim, Germany, as Droppo system.

In all these processes, the PEG melt is converted into droplets which then solidify to powder particles. The droplet size fixes the later particle size of the powder. The droplet size depends on the one hand on the pressure with which the melt is forced through the drop-forming nozzle, and on the other hand on the nozzle geometry.

The desired bimodal particle size distribution can be achieved by forcing the PEG melt under pulsating pressure through the nozzle device, or by using nozzles with two different geometries simultaneously side by side. In the case of the process using vibrating nozzle plates, a continuous variation in the vibration frequencies can also result in the desired bimodal particle size distribution.

The PEG melt is typically introduced at a temperature between 60 and 140° C. preferably between 70 and 120° C., particularly preferably between 80 and 110° C. The temperatures of the heated nozzles are likewise within these ranges. The nozzle orifice diameters are from 0.05 to 5 millimeters, preferably 0.1 to 3 millimeters, particularly preferably 0.5 to 2 millimeters.

The pressure with which the melt is forced through the nozzle device depends greatly on the viscosity, which in turn is very dependent on the average chain length, i.e. the average molecular mass of the PEG to be solidified, and on the temperature used. The pressure typically used is from 0.1 to 20 bar, preferably from 2 to 15 bar, particularly preferably from 5 to 12 bar. The droplets can be solidified to powder particles by using all conventional coolants such as, for example, air or cryogases such as nitrogen or carbon dioxide.

As result of their bimodal particle size distribution, PEG powders of the invention are able to fulfill very different functions and can therefore be employed universally in tableting and melt granulation processes.

### EXAMPLE

The following example is intended to explain the subject matter of the invention in detail without restricting it thereto.

Production of a PEG Powder with Bimodal Particle Size Distribution

PEG with an average molecular mass of 5500 was forced as melt at 120° C. under a pressure of 10 bar in a conventional spray-cooling system through nozzles of 0.9 mm and 2.0 mm diameter, and cooled. The PEG powder resulting in this case had a particle size distribution of 9% by weight of particles smaller than 100 micrometers, 32% by weight of particles between 100 and 200 micrometers, 14% by weight of particles between 200 and 300 micrometers, 41% by weight of particles between 300 and 800 micrometers and 4% by weight of particles larger than 800 micrometers.

1. Solid polyethylene glycol with an average molecular mass of from 1500 to 40 000 in the form of a powder with a bimodal particle size distribution, with from 0 to 15% by weight of particles smaller than 100 micrometers, 10 to 90% by weight of particles between 100 and 200 micrometers, 0 to 25% by weight of particles between 200 and 300 micrometers, 10 to 90% by weight of particles between 300 and 1000 micrometers and 0 to 10% by weight of particles larger than 1000 micrometers.

2. Solid polyethylene glycol with an average molecular mass of from 1500 to 40 000 in the form of a powder with a bimodal particle size distribution, with from 0 to 10% by weight of particles smaller than 100 micrometers, 20 to 80% by weight of particles between 100 and 200 micrometers, 0 to 15% by weight of particles between 200 and 300 micrometers, 20 to 80% by weight of particles between 300 and 800 micrometers and 0 to 10% by weight of particles larger than 800 micrometers.

3. The solid polyethylene glycol of claim 1, wherein said solid polyethylene glycol has an average molecular mass of from 3000 to 20 000.

4. The solid polyethylene glycol of claim 1, wherein said solid polyethylene glycol has an average molecular mass of from 3350 to 8000.

5. A method for producing the solid polyethylene glycol of claim 1, said method comprising simultaneously spraying polyethylene glycol as melt at elevated temperature through two different nozzles to form droplets and cooling the droplets to form the solid polyethylene glycol having bimodal particle size distribution.

6. A method for producing the solid polyethylene glycol of claim 1, said method comprising spraying the polyethylene glycol as melt at elevated temperature under pulsating pressure to form droplets and cooling the droplets to form the solid polyethylene glycol having bimodal particle size distribution.

7. A method for preparing tablets, said method comprising adding the solid polyethylene glycol of claim 1 to tablets as a shaping agent.

8. A method for melt granulation, said method comprising adding the solid polyethylene glycol of claim 1 to a melt prior to said melt granulation.

9. The method of claim 5, wherein the two different nozzles have different geometries.

10. The method of claim 5, wherein the elevated temperature ranges from 60 to 140° C.

11. The method of claim 5, wherein the two nozzles have orifices of differing orifice diameters ranging from 0.05 to 5 millimeters.

12. The method of claim 5, wherein the two nozzles are side by side.

13. A method for producing the solid polyethylene glycol of claim 1, said method comprising:
a) introducing a polyethylene glycol melt at a temperature greater than 60° C. to a nozzle means having different side-by-side geometries to provide polyethylene glycol droplets;
b) cooling the polyethylene glycol droplets to form the solid polyethylene glycol having bimodal particle size distribution.

14. The method of claim 13, wherein the nozzle means comprises at least two side-by-side nozzles having different geometries.

15. The method of claim 13, wherein the nozzle means comprises vibrating plates.

16. The method of claim 13, wherein said melt is introduced to the nozzle means at a constant pressure or a pulsating pressure.
